(19) United States
(12) Patent Application Publication
(10) Pub. No.: US 2011/0100479 A1
(43) Pub. Date: May 5, 2011

(54) DRAIN SYSTEM FOR A PIGGING DEVICE

(76) Inventor: Charles Malcolm DEVINE, Fort St. John (CA)

(21) Appl. No.: 12/938,627

(22) Filed: Nov. 3, 2010

Related U.S. Application Data
(60) Provisional application No. 61/257,950, filed on Nov. 4, 2009.

(51) Int. Cl. B08B 9/04

(52) U.S. Cl. 137/15.07; 15/3.5

(57) ABSTRACT

A drain system for a pigging device on a pipeline includes a pig receiving body connected to the pipeline by at least one pigging valve and being elevated above the pipeline. A drain is connected between the pig receiving body and the pipeline. The drain has a drain valve for selectively opening the drain and the drain drains fluids from the pig receiving body to the pipeline when the drain valve is open and the pressure in the pig receiving body is equalized to the pipeline.

### FIELD

This relates to a drain system for a pigging device, such as a pig launcher or receiver.

### BACKGROUND

Pipeline pigs are used to inspect and maintain pipelines. Pigs are generally cylindrically shaped and are approximately the same diameter as the pipeline. The pigs are introduced into the pipeline and then removed using pig launchers and receivers. As the pigs pass through the pipeline, they entrain fluids with them into the launcher/receiver areas.

FIG. 1 shows a schematic of a typically pig launcher/receiver with a pig receiving body 12, or pigging barrel, connected to a pipeline 14 by pigging valves 16 and 18, and a piping system 19. Pig receiving body 12 has an access door 15 to introduce or remove a pig, and is otherwise a sealed unit capable of withstanding pipeline pressures. Pigging valve 16 is the main pigging valve, which is either a launcher or a receiver valve, depending on its purpose, and valve 18 is an isolation valve for pig receiving body 12.

### SUMMARY

There is provided a drain system for a pigging device on a pipeline. A pig receiving body is connected to the pipeline by at least one pigging valve and is elevated above the pipeline. The pig receiving body may be either a pig launcher or a pig receiver. A drain is connected between the pig receiving body and the pipeline. Drain valves are used for selectively opening the drain and allowing fluids to drain from the pig receiving body to the pipeline when the drain valve is open and the pressure in the pig receiving body is equalized to the pipeline.

There is further provided a method of draining a pigging device. A pig receiving body is connected to the pipeline by at least one pigging valve and is elevated above the pipeline. A drain is connected between the pig receiving body and the pipeline. A pigging valve is opened and a drain valve on a drain is opened to allow fluids to be drained from the pig receiving body into the pipeline via the drain.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic view of a pig launcher labelled as PRIOR ART.

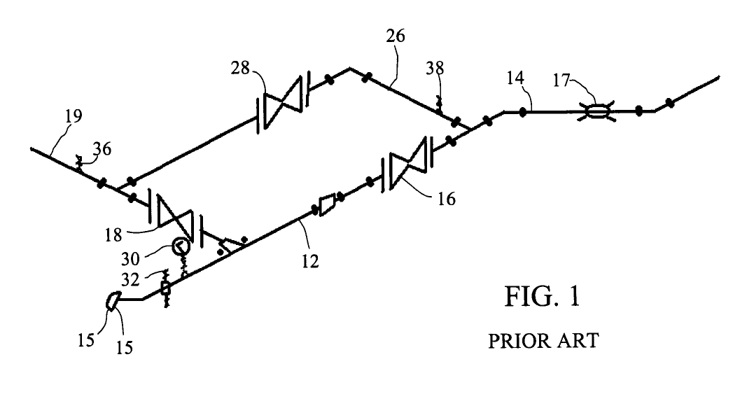

FIG. 2 is a schematic view of a drain system for a pig launcher attached to a pig launcher.

FIG. 3 is a schematic view of an additional embodiment of the drain system attached to a pig launcher shown in FIG. 2.

FIG. 4 is a schematic side elevation view of the drain system attached to a pig launcher shown in FIG. 3.

### DETAILED DESCRIPTION

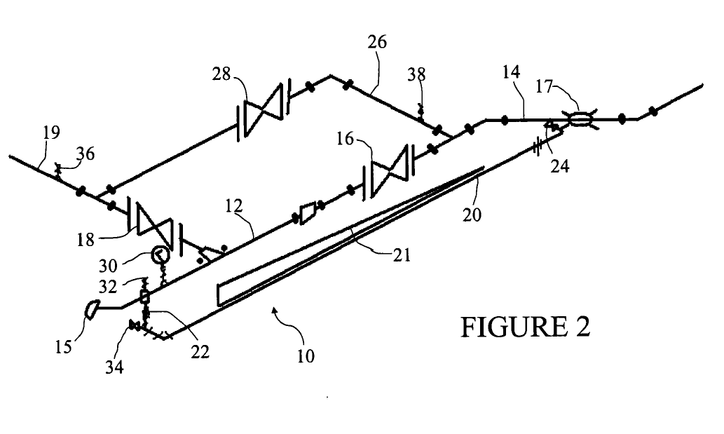

A drain system for a pigging body, generally identified by reference numeral 10, will now be described with reference to FIG. 2 through 4.

Drain system 10 described herein is a unique piping design that allows enclosed piping systems incorporating pigging devices, such as pig launchers and receivers, to drain undesirable liquids left in launchers, receivers or piping during pigging or normal operations, thus preventing environmental impact, contamination or freeze ups. When operated properly, the draining system will remove these undesirable liquids from low areas such as pig launcher/receivers gravitationally.

The draining system may be constructed from metal, plastic, fibreglass or composite depending on the components used in the piping system. The components and method of joining them is determined by component type, codes having jurisdiction and owner or owner's representative's preference. Joining methods may be welding, a combination of welding and mechanical such as welding and threaded or flanged, chemical bonding or compression. The most common type joining method used on metal pipe in the oil and gas industry is a combination of welding and mechanical, threaded or flanged.

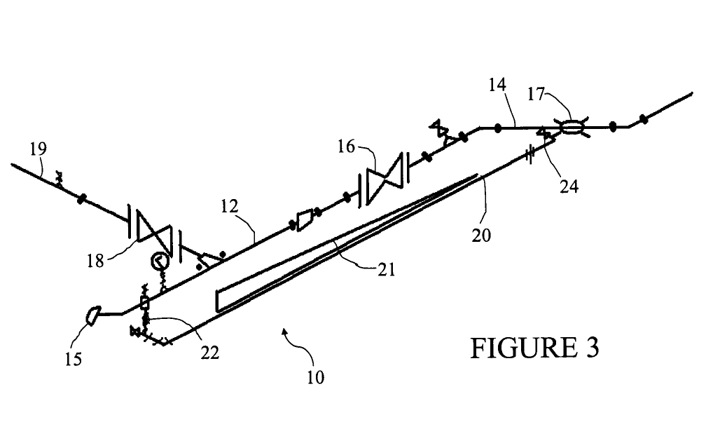

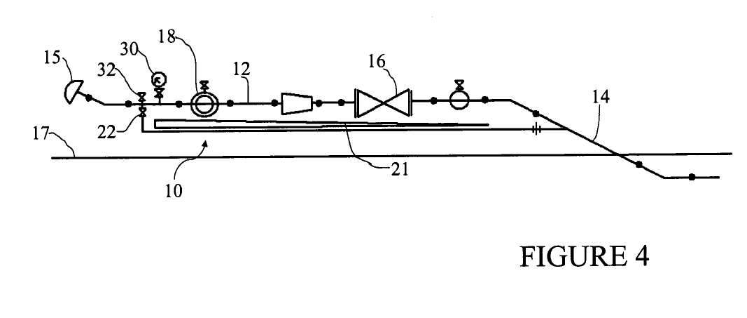

Referring now to FIG. 2, drain system 10 has a pig receiving body 12, or pigging barrel connected to a pipeline 14 by pigging valves 16 and 18 and a piping system 19. Pig receiving body 12 has an access door 15 to introduce or remove a pig, and is otherwise a sealed unit capable of withstanding pipeline pressures. Referring to FIG. 4, pig receiving body 12 is elevated above pipeline 14. As shown, pipeline 14 is below ground level 17, while pig receiving body 12 is above. Pig receiving body 12 may be a pig receiver, a pig launcher, or a pig receiver/launcher. An example of a pig launcher is shown in FIG. 3. The structure is substantially the same, and the difference is mostly defined by the manner in which they are used, although some minor differences may be encountered. Pigging valve 16 is the main pigging valve, which is either a launcher or a receiver valve, depending on its purpose, and valve 18 is an isolation valve for pig receiving body 12.

Referring again to FIG. 2, there is a drain 20 connected between pig receiving body 12 and pipeline 14. As shown, drain 20 is a fluid line connected between pigging body 12 and pipeline 14 with valves 22 and 24 at either end. While only one valve is necessary to open and close drain, using more valves provides additional control and some redundancy. Drain valves 22 and 24 can be opened and closed to drain fluids through drain 20 from pig receiving body 12 to pipeline 14. This occurs when the drain valve is open and the pressure in the pig receiving body is equalized to the pressure in the pipeline. As pig receiving body 12 is elevated above pipeline 14, any fluid in pig receiving body 12 is permitted to drain by gravity to pipeline 14. Preferably, drain 20 is connected to a low point of pig receiving body 12 to help remove more fluids.

To allow the fluid to flow by gravity through drain 20, drain 20 has a downward slope, represented by slope line 21. The degree of slope away from the area being drained may be determined by the user. The number of direction changes in drain system 10 required by the physical structure of the piping system are preferably minimized. Liquid traps, pockets and other drainage restrictions in drain system 10 are preferably avoided to ensure adequate drainage. The system should be regularly maintained.

The draining system may be easily installed in new piping systems during construction. Where piping systems are already in service, it may be installed by means of a hot tap. A hot tap is a procedure in which a fitting with a closed valve installed may be welded to a pipe in an operational system and a hot tap machine connected to the valve. The valve is opened to allow a hole to be drilled in the pipe through the valve, the drill is then retracted, the valve closed and the hot tap machine disconnected from the closed valve allowing the draining system to be completed safely.

### EXAMPLES

Referring to FIG. 2, the depicted example has a bypass line 26 with a bypass line isolation valve 28. In communication with pig receiving body 12 is a pressure indicator 30. As shown, drain 20 may also have an injection valve 34, which allows drain line 20 to be blown out. Bleed valves 32, 36 and 38 may also be provided to relieve pressure in the system when necessary. The upstream connection of the draining system should be installed at the lowest point of piping 19 to be drained, such as the launcher/receiver barrel 12 as shown in the enclosed drawings. The connection for the launcher/receiver bleed valve 32 is preferably directly above the launcher/receiver drain valve 22 to allow rodding should it become necessary. Other valves may also be added at direction changes on the draining system to facilitate rodding based on the preferences of the user. Draining system 10 ties into the upstream or downstream riser isolation valve 24 at a point below injection valve 34 and drain valve 22 to facilitate drainage.

It will be understood that not all launcher/receiver operations have exactly the same configuration, valve opening/closing sequences or procedures, and what is depicted is merely an example of one type. However, once the principles described herein are understood, drain system 10 can be suitably installed with the different designs. It will also be understood that not all components are depicted, as these components are well known in the art.

Referring now to FIG. 2, under normal operating conditions, the direction of flow will be up from bypass isolation valve 2 is open, and pigging valves 16 and 18 are closed, as are valves 22 and 24. The fluid in pipeline 14 flows through bypass line 26, and pig receiving body 12 is isolated from pipeline 14. When a pig is to be launched a pig is introduced into pig receiving body 12 through access door 15. Pressure is applied to move pig by opening main pigging valve 16 and isolation valve 18, while closing bypass isolation valve 28. As pressure is diverted from bypass line 26 into pig receiving body 12, the pressure differential between the pipeline 14 upstream and downstream of the pig causes it to be launched into pipeline 14. The pig is received into pig receiving body 12 by a reverse procedure and under revers flow conditions, but with similar valve positions.

Referring now to FIG. 3, an example of a pig launcher without a bypass line is shown. In this example, isolation valve 18 and pigging valve 16 are closed such that a pig may be introduced through access door 15. Valves 16 and 18 are then opened, such that the pig is launched into pipeline 14 due to the back pressure.

In each situation, when valves 16 and 18 are opened, pressure and fluid are introduced into pig receiving body 12 and piping 19 generally. Closing these valves then seals the fluid and pressure in body 12. This may be immediately after a pig has been launched, before a pig is introduced, or after a pig has been received. At this point, fluid is drained out of pig receiving body 12 by opening valves 22 and 24 and allowing fluid to flow through drain 20 into pipeline 14. Pressure is equalized within drain 20 by the sealing of different valves to allow gravitational drainage.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A drain system for a pigging device on a pipeline, comprising:
a pig receiving body connected to the pipeline by at least one pigging valve, the pig receiving body being elevated above the pipeline; and
a drain connected between the pig receiving body and the pipeline, the drain having a drain valve for selectively opening the drain, the drain draining fluids from the pig receiving body to the pipeline when the drain valve is open and the pressure in the pig receiving body is equalized to the pipeline.

2. The drain system of claim 1, wherein the pig receiving body is a pig launcher, and the pigging valve is a pig launching valve.

3. The drain system of claim 1, wherein the pig receiving body is a pig receiver, and the pigging valve is a pig receiving valve.

4. The drain system of claim 1, wherein the pig receiving body is a pig launcher/receiver, and is connected to the pipeline by a pig launching valve and a pig receiving valve.

5. The drain system of claim 1, wherein the drain is connected to a low point of the pig receiving body.

6. The drain system of claim 1, wherein the drain is a gravity-fed drain.

7. A method of draining a pigging device, comprising the steps of:
providing a pig receiving body connected to the pipeline by at least one pigging valve, the pig receiving body being elevated above the pipeline;
opening at least one of the at least one pigging valve; and
opening a drain valve on a drain connected between the pig receiving body and the pipeline;
draining fluids from the pig receiving body into the pipeline via the drain.
